(19) United States
(12) Patent Application Publication
(10) Pub. No.: US 2024/0249868 A1
(43) Pub. Date: Jul. 25, 2024

(54) METHOD FOR REPLACING SALTS OF A SELF-REGENERATING BREATHER DEVICE OF A POWER ELECTRICAL APPARATUS

(71) Applicant: Comem S.P.A., Montebello Vicentino VI (IT)

(72) Inventors: Gianmaria UGOLIN, Montebello Vicentino VI (IT); Francesca NUCCI, Montebello Vicentino VI (IT); Andrea TONIN, Montebello Vicentino VI (IT)

(73) Assignee: Comem S.P.A., Montebello Vicentino VI (IT)

(21) Appl. No.: 18/560,424

(22) PCT Filed: May 12, 2022
(86) PCT No.: PCT/IT2022/050124

§ 371 Date: Nov. 13, 2023

(30) Foreign Application Priority Data
May 13, 2021 (IT) 102021000012281

(51) Int. Cl. H01F 27/14; B01D 53/26

(52) U.S. Cl. CPC H01F 27/14; B01D 53/261; B01D 2257/80

(57) ABSTRACT

A method for replacing salts inside a self-regenerating breather device for power electrical apparatus, such as transformers, comprising the following steps:
disconnecting said self-regenerating breather device from a suction duct of a power electrical apparatus;
rotating and overturning said breather device;
opening a lower flange (15) of the breather device;
removing a split pin or another closing system and removing a closure net (16) of the tank (12) of said self-regenerating breather device, said tank (12) containing said salts to be replaced;
replacing said salts by completely overturning said breather device over a container;
further overturning said breather device;
filling said tank (12) with new salts.

The present invention generically relates to a process for replacing salts inside self-regenerating breathers to dehumidify air for oil expansion vessels used in power electrical apparatus, in particular oil-insulated, such as power electrical transformers, on-load tap changers and so on.

The invention relates in particular to a method of replacing oil-polluted salts, which is realised by operating directly on the breather.

It is well known that power apparatus containing insulating oil usually includes an oil expansion tank whose function is to compensate for the inevitable volume variations of the oil inside the transformer caused by temperature changes.

This oil expansion vessel is supplied with air that has been previously treated in a special breather to remove or drastically reduce its moisture.

This is because air supplied to an oil expansion tank even with a minimal amount of residual moisture would have the negative side effect of reducing the breakdown tension of the insulating oil.

In their essential and main features, examples of known breather types include an outer casing, an electronic board and a regeneration system with a desiccant tank.

The reservoir, which has at least one inlet opening for the air to be dehumidified and at least one outlet opening for the dehumidified air, contains within it a desiccant (such as Silica Gel) and/or absorption means (comprising a plurality of thermally regenerable granules or salts), suitable for dehumidifying the air coming from the outside, a drying system and means for detecting the degree of humidity of the dehumidified air, operatively connected to the heating element.

For example, the regeneration system may be a heating resistor, which is responsible for the thermal regeneration of the absorption media.

Typically, the means for activating the regeneration procedure include humidity sensors, arranged outside the tank and preferably near the outlet opening of the dehumidified air, or load cells or timers.

For example, the humidity sensor detects the value of residual moisture in the dry air and triggers the activation of the heating resistor if this value exceeds a maximum permissible value; this means, in fact, that the absorption media have lost or are losing their absorption capacity and must be regenerated.

However, due to oil filling errors in the transformer, it is possible for oil to enter the dryer's main tank, thus polluting the salts inside.

Because of this, it is currently not possible to replace the salts on site, so the entire breather must be replaced.

The present invention intends to solve this problem of the prior art.

In particular, the primary object of the invention is to disclose a process for replacing salts inside self-regenerating breather for power electrical apparatus, such as electrical transformers, which enables the replacement of said salts, which may have been polluted by oil due to oil filling errors in the transformer, directly by operating on the drier and without the need to move or replace it.

It is a further object of the present invention to disclose a process for replacing salts within self-regenerating breathers for power electrical apparatus, such as electrical transformers, which enables such replacement to be carried out quickly and easily.

These and other purposes are achieved by a process for replacing salts present within self-regenerating breather for power electrical apparatuses, such as electrical transformers, according to claim 1 appended hereto; other detailed technical features of the process are set forth in the related dependent claims.

Advantageously, the breather is designed so that, in the event of an oil filling error in the power electric apparatus, it is easy and quick to replace the oil-polluted salts in the main reservoir of the breather.

The above-mentioned purposes and advantages will become more apparent in the following, thanks to the description of a preferred embodiment of the invention, provided by way of example but not limitation, and the accompanying drawings, in which:

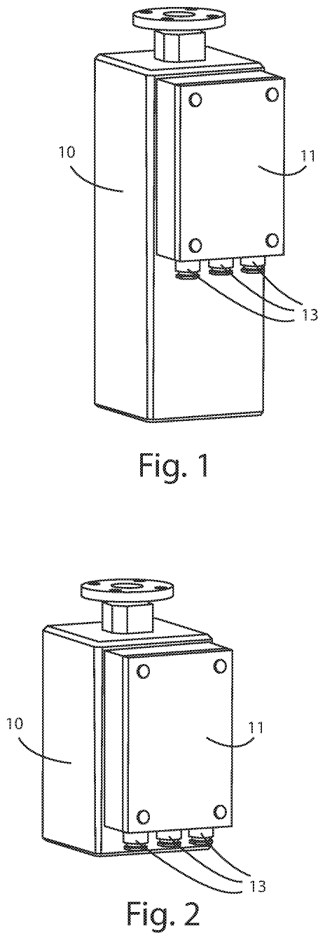

FIGS. 1 and 2 show two perspective views of two types of self-regenerating breathers for which the process according to the present invention is realised;

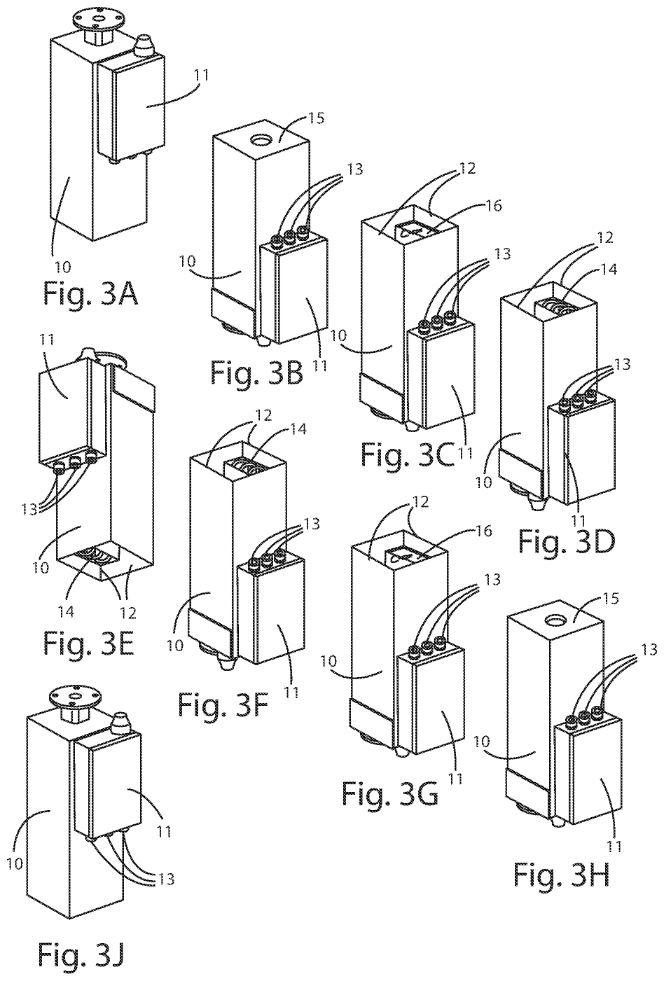

FIGS. 3A, 3B, 3C, 3D, 3E, 3F, 3G, 3H and 3J show the various steps in the procedure for replacing salts inside a self-regenerating breather for power electrical apparatus, such as electrical transformers, according to the present invention.

With reference to the above-mentioned figures, an embodiment of a self-regenerating breather for power electrical apparatus, such as electrical transformers, according to the invention, comprises an external casing 10, an electronic board 11, at least one internal tank 12. Optionally, where there is more than one tank, there is a three-way solenoid valve 13, including two inlet ways and one outlet way, which determines in which of the tanks the air is circulating.

Each tank 12 has at least one inlet opening for the air to be dehumidified and at least one outlet opening for the dehumidified air, and contains within it a desiccant element (Silica Gel) and/or other absorption means (granules or thermally regenerable salts), suitable for dehumidifying the air coming from outside, as well as a heating resistor 14 and means for detecting the degree of humidity of the dehumidified air operatively connected to the heating resistor 14.

Clearly, other types of regeneration systems, other than resistance, and/or other types of activation means for regeneration systems may be included instead.

According to the present invention, the process for replacing salts in situ comprises the following phases.

First of all, the self-regenerating breather must be disconnected from the suction duct of the power-electrical apparatus (such as the electrical transformer) and then the breather must be rotated and overturned completely (FIG. 3A, 3B enclosed) and the lower closing flange 15 of the breather must be opened (FIG. 3C enclosed).

At this point, a split pin or other closure system is removed and the net 16 of the tank 12 in which the salt is to be replaced is removed (FIG. 3D enclosed) and the salt is removed by overturning and tipping the dryer onto a suitable container (FIG. 3E enclosed).

Then the breather is overturned again, cleaning the tank 12 if necessary and filling it with new salt (FIG. 3F enclosed).

The tank 12 is then closed again with the cotter pin and closing net 16 (FIG. 3G enclosed), the lower flange 15 is fixed (FIG. 3H enclosed) and the self-regenerating breather is connected again to the suction line of the power electrical apparatus, such as the electrical transformer (FIG. 3J enclosed).

By virtue of the foregoing, it is therefore understood how the process for replacing salts inside self-regenerating breathers, according to the invention, achieves the objectives and realises the aforementioned advantages, consisting primarily in the possibility of replacing salts in situ quickly and easily, without having to replace the self-regenerating breather, in the event of an oil filling error in the power electric apparatus and, therefore, possible entry of oil into the main breather tank.

Finally, it is clear that numerous other variations of the replacement process for the salts in question may be realised, without departing from the principles of novelty inherent in the inventive idea expressed in the appended claims, just as it is clear that, in the practical implementation of the invention, the materials, shapes and sizes of the illustrated details may be any as required and may be replaced with technically equivalent ones.

1. Method for replacing salts of a self-regenerating breather device for dehumidifying air to be supplied to an oil expansion vessel of a power electrical apparatus, such as a power electrical transformer, wherein said self-regenerating breather device comprises an external casing, an electronic operating board, at least one tank, said tank having at least a first inlet opening for passing air to be dehumidified and at least one second outlet opening for passing dehumidified air and said tank containing thermally regenerable salts which are used for dehumidifying air coming from the outside, said self-regenerating breather device also including a regeneration system and actuation means of said regeneration system, said actuation means being operatively connected to said regeneration system, characterized in that said method comprises the following phases:
disconnecting said self-regenerating breather device from a suction duct of a power electrical apparatus;
rotating and overturning said breather device;
opening a closing flange of the breather device;
removing a split pin and removing a closure net of the tank of said self-regenerating breather device, said tank containing said salts to be replaced;
replacing said salts by completely overturning said breather device over a container;
further overturning said breather device;
filling said tank with new salts.

2. Method for replacing salts as claimed in claim 1, wherein after said phase of further overturning said breather device, a cleaning step of said tank is carried out.

3. Method for replacing salts as claimed in claim 1, wherein after said step of filling said tank with new salts, said reservoir is closed with said split pin and with said closure net.

4. Method for replacing salts as claimed in claim 3, wherein after said closing phase of said tank, said closing flange is fixed and then said self-regenerating breather device is connected again to said suction duct of said power electrical apparatus.

5. Method for replacing salts as claimed in claim 2, wherein after said step of filling said tank with new salts, said reservoir is closed with said split pin and with said closure net.
